(19) United States
(12) Patent Application Publication
(10) Pub. No.: US 2020/0284173 A1
(43) Pub. Date: Sep. 10, 2020

(54) SINTERED FERROUS ALLOY VALVE SEAT EXHIBITING EXCELLENT THERMAL CONDUCTIVITY FOR USE IN INTERNAL COMBUSTION ENGINE

(71) Applicant: NIPPON PISTON RING CO., LTD., Saitama-shi (JP)

(72) Inventors: Ayato OIKAWA, Tochigi (JP); Seisuke TAKAKI, Tochigi (JP); Hiroshi OSHIGE, Tochigi (JP); Kenichi SATO, Tochigi (JP)

(21) Appl. No.: 16/494,878

(22) PCT Filed: Mar. 23, 2018
(86) PCT No.: PCT/JP2018/011581

§ 371 Date: Sep. 17, 2019

(30) Foreign Application Priority Data
Mar. 27, 2017 (JP) 2017-060626

(51) Int. Cl. F01L 3/02; B22F 5/10; B22F 3/26; B22F 3/10

(52) U.S. Cl. CPC F01L 3/02; B22F 5/10; B22F 3/26; B22F 2301/10; F05C 2201/0436; F05C 2201/0475; B22F 2301/35; B22F 3/10

(57) ABSTRACT

Disclosed is a copper-infiltrated valve seat insert of an iron-base sintered alloy having a two-layer structure formed by integrating a functional member side layer and a supporting member side layer across a boundary, and the thermal conductivity rate at 300° C. is 25 W/m·K or more in the functional member side layer and 60 W/m·K or more in the supporting member side layer.

### TECHNICAL FIELD

The present invention relates to a valve seat insert made of an iron-base sintered alloy for internal combustion engines, and more particularly to a valve seat insert maintaining wear resistance and having improved thermal conductivity.

### BACKGROUND ART

In an internal combustion engine, a valve seat insert on which a valve is to be seated is required to maintain wear resistance high enough for withstanding wear due to repeating contact with the valve and superior thermal conductivity as well as to maintain the airtightness of the combustion chamber. In particular, the thermal conductivity of a valve seat insert is a characteristic that greatly affects engine output, and therefore it has been desired to maintain superior thermal conductivity of a valve seat insert.

Moreover, in recent years, valve seat inserts with a two-layer structure made of different materials have been applied. In such a two-layered valve seat insert, a functional member side layer formed of a material having superior wear resistance is disposed on a valve contact face side where a valve is to be seated and a material having superior thermal conductivity is disposed as a supporting member side layer on a seating face side where the valve seat insert is to come into contact with a cylinder head, and the two layers are integrated. In recent years, most of valve seat inserts having such a structure are made of sintered alloys using powder metallurgy because of high dimensional accuracy and the ability to use special alloys.

With the recent promotion of higher efficiency and higher load of internal combustion engines, the temperature around combustion chambers tends to further increase, so that there is a concern about the occurrence of knocking. In order to suppress the occurrence of knocking and achieve higher efficiency of internal combustion engines, lowering the temperature of valves and valve seat inserts is considered to be an important point in the future.

For such needs, for example, Patent Literature 1 describes a sintered valve seat insert for internal combustion engines that exhibits good machinability, wear resistance and high heat transfer property. According to the technology described in Patent Literature 1, it is taught to use, as a material (a mixture) for valve seat inserts, a material comprising a sinter-hardenable ferrous powder forming 75-90%, in weight %, of the mixture, preferably 5 to 25% of a tool steel powder, a solid lubricant, and Cu added by infiltration during sintering. In addition, according to the technology described in Patent Literature 1, the ferrous powder to be used is preferably a ferrous powder containing 2 to 5% of Cr, 0 to 3% of Mo and 0 to 2% of Ni, in weight %, the solid lubricant is preferably 1 to 5% of a solid lubricant selected from one or more of the group consisting of MnS, CaF₂ and MoS₂, and the Cu added by infiltration into a molding body during sintering is preferably made to account for 10 to 25%, in weight %, of the molding body. As a result, it is taught that pores are filled with the Cu alloy, so that the thermal conductivity is greatly improved. According to the technology described in Patent Literature 1, a sintered valve seat insert for internal combustion engines that exhibits good machinability, wear resistance and high heat transfer property can be obtained.

Further, Patent Literature 2 describes a valve seat insert for internal combustion engines which is superior in cooling ability. According to the technology described in Patent Literature 2, there is proposed a valve seat insert of an iron-base sintered alloy for internal combustion engines in which two layers of a valve-contacting face side layer and a seating face side layer are integrated, which is configured to be a valve seat insert in which the valve-contacting face side layer accounts for 10 to 45% in volume % with respect to the entire valve seat insert and which includes a valve-contacting face side layer that is extremely thin as compared with conventional products. It is reported that due to this configuration, there is obtained a two-layered valve seat insert for internal combustion engines which is suitable for internal combustion engines, includes both superior wear resistance and superior thermal conductivity, and has high cooling ability. According to the technology described in Patent Literature 2, in order to stably achieve a thin valve-contacting face side layer, the boundary between the valve-contacting face side layer and the seating face side layer preferably forms an angle with a valve seat insert axis being an average angle α of 20° or more and 90° or less and the boundary is preferably adjusted to ±300 μm or less in the height direction with respect to the average position of the boundary. According to the technology described in Patent Literature 2, it is preferable that the valve-contacting face side layer is formed of an iron-base sintered alloy having a matrix part in which hard particles are dispersed in a matrix phase, wherein the matrix part has a matrix part composition containing C: 0.2 to 2.0% in mass % and one kind or two or more kinds selected from among Co, Mo, Si, Cr, Ni, Mn, W, V, S, Ca and F in a total amount of 40% or less with the balance being Fe and unavoidable impurities, and a matrix part structure in which hard particles are dispersed in a matrix phase 5 to 40% in mass % with respect to the entire valve-contacting face side layer, and the seating face side layer is formed of an iron-base sintered alloy having a composition containing C: 0.2% to 2.0% in mass % with the balance being Fe and unavoidable impurities.

Further, Patent Literature 3 describes a valve seat insert of an iron-base sintered alloy for internal combustion engines which is superior in thermal conductivity. The technology described in Patent Literature 3 is a valve seat insert of an iron-base sintered alloy for internal combustion engines, in which a valve-contacting face side layer and a supporting member side layer are integrated, wherein the supporting member side layer is formed to be a layer having a thermal conductivity rate at 20 to 300° C. of 23 to 50 W/m·K, and the valve-contacting face side layer is formed to be a layer having a thermal conductivity rate at 20 to 300° C. of 10 to 22 W/m·K, and the valve-contacting face side layer is made as thin as possible, the supporting member layer is made thick, and the contacting face to a cylinder head is made wide. Therefore, the boundary between the valve-contacting face side layer and the supporting member side layer is formed in a region surrounded by a face that includes a circular line being 0.5 mm apart from the valve contact face toward the supporting member side at the central position in the width direction of the valve contact face and has an angle of 45° with respect to the valve seat insert axis and a face that includes the line of intersection of the inner circumferential face and the seating face of the valve seat insert and a circular line having a distance of ½ of the valve seat insert height from the seating face of the valve seat insert on the outer circumferential face of the valve seat insert. It is taught that in order to stably form the boundary with the above-described shape, it is important to adjust the balance between the molding face shape of a provisional pressing punch and the molding pressure during provisional pressing when a mixed powder for the supporting material side layer is provisionally pressed using the provisional pressing punch, and adjust the molding pressure of an upper punch when further integrally pressing a mixed powder for the supporting member side layer and a mixed powder for the valve-contacting face side layer.

According to the technology described in Patent Literature 3, it is preferable that the valve-contacting face side layer is formed of an iron-base sintered alloy having a matrix part in which hard particles are dispersed in a matrix phase, wherein the matrix part has a matrix part composition containing C: 0.2 to 2.0% in mass % and one kind or two or more kinds selected from among Co, Mo, Si, Cr, Ni, Mn, W, V, S, Ca and F in a total amount of 40% or less with the balance being Fe and unavoidable impurities, and a matrix part structure in which hard particles are dispersed in a matrix phase 5 to 40% in mass % with respect to the entire valve-contacting face side layer, and the supporting member side layer is formed of an iron-base sintered alloy having a matrix part composition containing C: 0.2% to 2.0% in mass % with the balance being Fe and unavoidable impurities. According to the technology described in Patent Literature 3, a thin valve seat insert having a stable boundary of two layers can be produced extremely easily as compared with conventional technologies and there can be formed a valve seat insert which is suitable for internal combustion engines and secures high thermal conductivity while maintaining superior wear resistance.

Patent Literature 4 describes a highly thermally conductive valve seat insert ring. The technology described in Patent Literature 4 is a valve seat insert ring having a carrier layer and a functional layer produced by a powder metallurgy method, which is characterized by having a thermal conductivity rate exceeding 55 W/m·K. According to the technology described in Patent Literature 4, the carrier material forming the carrier layer and/or the functional material forming the functional layer contains copper added by infiltration, and the carrier material forming the carrier layer is formed of an iron-copper alloy and preferably contains more than 25% and 40% or less, in weight %, of copper, and the functional material forming the functional layer preferably contains 8.0% or more of copper. The carrier material forming the carrier layer further contains 0.5 to 1.8% of C, 0.1 to 0.5% of Mn, and 0.1 to 0.5% of S, expressed in weight %, and contains Fe as the balance. In addition, the functional material forming the functional layer further contains 0.5 to 1.2% C, 6.0 to 12.0% Co, 1.0 to 3.5% of Mo, 0.5 to 3.0% of Ni, 1.5 to 5.0% of Cr, 0.1 to 1.0% of Mn and 0.1 to 1.0% of S, expressed in weight %, and contains Fe as the balance.

### CITATION LIST

### Patent Literature

Patent Literature 1: JP 2004-522860 A
Patent Literature 2: JP 2011-157845 A
Patent Literature 3: JP 2015-127520 A
Patent Literature 4: JP 2015-528053 A

### SUMMARY OF INVENTION

### Technical Problem

However, according to the technology described in Patent Literature 1, a valve seat insert having thermal conductivity corresponding to a thermal conductivity rate at 300° C. of about 41 W/m·K can be obtained, but there is a problem that adhesion of Cu readily occurs because the amount of Cu added by infiltration is as large as 10% by weight or more, and wear resistance deteriorates due to the adhesion of Cu because no adhesion prevention measures such as hard particles, etc. are taken, so that it is impossible to stably produce valve seat inserts having both thermal conductivity and wear resistance. In addition, there is also a problem that a recent demand for valve seat inserts of further improvement in thermal conductivity such as a thermal conductivity rate at 300° C. of more than 50 W/m·K cannot be satisfied.

Further, the technology described in Patent Literature 2 is problematic in that improvement in thermal conductivity is insufficient and a recent demand of further improvement in thermal conductivity such as a thermal conductivity rate at 300° C. of more than 45 W/m·K cannot be satisfied.

The valve seat insert produced by the technology described in Patent Literature 3 is a valve seat insert having a thermal conductivity rate at 20 to 300° C. of 23 to 50 W/m·K in a supporting member side layer and 10 to 22 W/m·K in a valve-contacting face side layer. Therefore, the technology described in Patent Literature 3 is problematic in that it is difficult to produce a valve seat insert having recently demanded high thermal conductivity such as a thermal conductivity rate at 300° C. of more than 45 W/m·K on average. Further, the technology described in Patent Literature 3 is problematic in that in order to achieve a configuration where the contact face with a cylinder head is enlarged by thinning the valve-contacting face side layer as much as possible and thickening the supporting member layer as much as possible, it is necessary to adjust the boundary between the valve-contacting face side layer and the supporting member layer by using a provisional pressing punch and a pressing facility having a complicated structure is required.

Further, the technology described in Patent Literature 4 is problematic in that in the functional layer, the amount of Cu added by infiltration is as large as 8% by weight or more and condense of Cu readily occurs, but wear resistance readily deteriorates because no measures for preventing adhesion of Cu is taken, so that valve seat inserts having both thermal conductivity and wear resistance cannot be produced stably.

In view of these problems with the existing technologies, it is an object of the present invention to provide a two-layered valve seat insert of an iron-base sintered alloy for internal combustion engines which can be manufactured without using a manufacturing facility having a complicated structure, and which has a thermal conductivity as high as the thermal conductivity rate at 300° C. is 25 W/m·K or more in a functional member side layer and is 60 W/m·K or more in a supporting member side layer and the thermal conductivity rate at 300° C. is higher than 45 W/m·K as the overall valve seat insert (average) without significantly reducing wear resistance as compared with conventional products, that is, which has both superior wear resistance and high thermal conductivity.

### Solution to Problem

In order to achieve the above-mentioned object, the present inventors paid attention to a two-layered valve seat insert made of an iron-base sintered alloy subjected to copper infiltration treatment. Then, the influence of the amount of Cu added by infiltration on the thermal conductivity in the functional member side layer and the supporting member side layer was investigated first. As a result, the thermal conductivity can be improved by copper infiltration treatment as conventionally known. However, it was found that in order that the thermal conductivity rate at 300° C. satisfies 25 W/m·K or more in the functional member side layer, it is necessary to adjust the amount of Cu added by infiltration (the Cu infiltration amount) to 10 volume % or more, and in order that the thermal conductivity rate at 300° C. satisfies 60 W/m·K or more in the supporting member side layer, it is necessary to adjust the Cu infiltration amount to 15 volume % or more.

Then, the wear resistance of a functional member side layer subjected to copper infiltration treatment was investigated. As a result, with increase in the amount of Cu added by infiltration, thermal conductivity is improved, but the amount of wear increases due to condense of Cu and wear resistance decreases conversely. However, it was newly found that by making a prescribed amount or more of a phase in which a fine carbide has precipitated (a fine carbide precipitation phase) exist as a matrix phase and dispersing a prescribed amount or more of hard particles in the matrix phase, condense of Cu can be suppressed and wear resistance is reduced slightly.

The invention has been completed by a further investigation based on such finding. That is, the gist of the present invention is as follows.

(1) A valve seat insert made of an iron-base sintered alloy for internal combustion engines, the valve seat insert being formed by integrating two of a functional member side layer and a supporting member side layer, wherein Cu is infiltrated in pores of the functional member side layer and the supporting member side layer, a valve contacting face is formed on the functional member side layer, and the valve seat insert is superior in a thermal conductivity as thermal conductivity rate of the functional member side layer at 300° C. is 25 W/m·K or more, a thermal conductivity rate of the supporting member side layer at 300° C. is 60 W/m·K or more, and a thermal conductivity rate at 300° C. is 45 W/m·K or more on average as the valve seat insert.

(2) The valve seat insert made of an iron-base sintered alloy for internal combustion engines according to (1), wherein the functional member side layer accounts for 10 to 40% in volume % with respect to the entire valve seat insert.

(3) A valve seat insert made of an iron-base sintered alloy for internal combustion engines, characterized in that, in (1) or (2), the functional member side layer is a layer that comprises a matrix part in which hard particles are dispersed in a matrix phase and pores filled with Cu by infiltration, wherein the matrix phase has a matrix phase structure including a fine carbide precipitation phase in an amount of 15% or more in volume % with respect to the entire matrix phase and less than 80% including 0% of a tempered martensite phase or pearlite, a martensite phase and a high alloy phase, the matrix part has a matrix part structure formed by dispersing the hard particles with a Vickers hardness of 600 to 1200 HV, 10 to 30% in volume % with respect to the entire matrix part in the matrix phase, and a matrix part composition which contains C: 0.5 to 2.0% in mass % with respect to the entire matrix part and contains one kind or two or more kinds selected from among Co, Mo, Si, Cr, Ni, Mn, W, V, S, Ca, F, Cu and Mg in a total amount of 45% or less, with the balance being Fe and unavoidable impurities, and further contains the Cu filled in the pores by infiltration in an amount of 10 to 35% in volume % with respect to the entire functional member side layer, and

the supporting member side layer is a layer that comprises a matrix phase and pores filled with Cu by infiltration, wherein the matrix phase has a matrix phase composition which contains C: 0.5 to 2.0% in mass % with respect to the entire matrix phase with the balance being Fe and unavoidable impurities, and further contains the Cu filled in the pores by infiltration in an amount of 15 to 35% in volume % with respect to the entire supporting member side layer.

(4) A valve seat insert made of an iron-base sintered alloy for internal combustion engines, characterized in that, in any one of (1) to (3), the functional member side layer includes, in addition to the matrix part structure, a matrix part structure formed by dispersing solid lubricant particles in an amount of 0.1 to 5.0% in volume % with respect to the entire matrix part.

(5) A valve seat insert made of an iron-base sintered alloy for internal combustion engines, characterized in that, in (3) or (4), the supporting member side layer has, in addition to the matrix phase composition, a matrix phase composition containing one kind or two or more kinds selected from among Mo, Si, Cr, Ni, Mn, W, V, S, Cu and Co in a total amount of 10% or less in mass % with respect to the entire matrix phase.

(6) A valve seat insert made of an iron-base sintered alloy for internal combustion engines, characterized in that, in (3) or (4), instead of the supporting member side layer, the supporting member side layer is a layer that has a matrix phase and pores filled with Cu by infiltration, includes a matrix part formed by dispersing solid lubricant particles in the matrix phase, has a matrix part structure formed by dispersing the solid lubricant particles in an amount of 0.1 to 4.0% in volume % with respect to the entire matrix part and a matrix part composition containing C: 0.5 to 2.0% in mass % with respect to the entire matrix part and containing one kind or two or more kinds selected from among Mo, Si, Cr, Ni, Mn, W, V, S, Ca, F, Cu, Co and Mg in a total amount of 15% or less, and further contains the Cu filled in the pores by infiltration in an amount of 15 to 35% in volume % with respect to the entire supporting member side layer.

### Advantageous Effects of Invention

According to the present invention, it is possible to easily and inexpensively provide a valve seat insert of an iron-base sintered alloy for internal combustion engines, which is able to be produced without using any manufacturing facility with a complicated structure and which has both superior wear resistance and high thermal conductivity, and an industrially significant effect can be exerted. Furthermore, according to the present invention, there is also exerted an effect of being able to afford a valve seat insert of an iron-base sintered alloy for internal combustion engines having high thermal conductivity without significantly reducing wear resistance as compared with conventional technologies.

### BRIEF DESCRIPTION OF DRAWINGS

FIG. 1 is an explanatory view schematically showing an example of a cross section of a two-layered valve seat insert to be targeted in the present invention.

FIG. 2 is an explanatory view schematically showing an outline of the single piece rig testing machine used in the examples.

### DESCRIPTION OF EMBODIMENTS

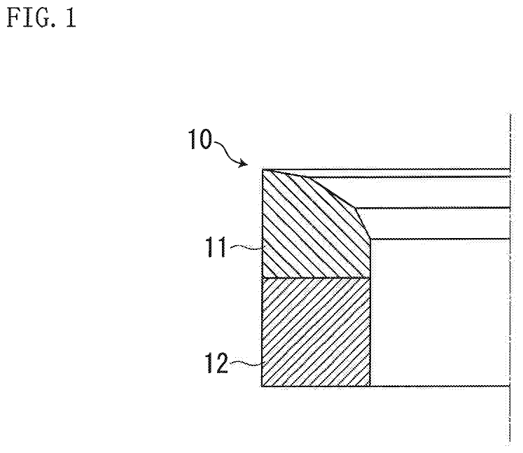

The valve seat insert 10 of the present invention is, as shown in FIG. 1, a valve seat insert of an iron-base sintered alloy for internal combustion engines formed by integrating two layers of a functional member side layer 11 and a supporting member side layer 12. The valve seat insert of the present invention includes a functional member side layer on the side where the valve seat insert is to come into contact with a valve and a supporting member side layer on the side where the valve seat insert is to come into contact with a seating face of a cylinder head, and the valve seat insert is formed by integrating two layers of the functional member side layer and the supporting member side layer.

In the valve seat insert of the present invention, the functional member side layer is provided with at least a valve contact face, and it is preferable that the functional member side layer be configured to account for 10 to 40% in volume % with respect to the entire valve seat insert. If the functional member side layer accounts for less than 10% in volume % with respect to the entire valve seat insert, the functional member side layer is excessively thin and the durability of the valve seat insert is reduced. In contrast, if the functional member side layer accounts for more than 40% in volume % with respect to the entire valve seat insert, the functional member side layer is excessively thick and the thermal conductivity is reduced. Preferably, the functional member side layer accounts for 15 to 35% in volume % with respect to the entire valve seat insert.

In the valve seat insert of the present invention, the functional member side layer includes a matrix part in which hard particles are dispersed in a matrix phase. By dispersing the hard particles in the matrix phase, the wear resistance of the valve seat insert is improved. In the functional member side layer in the valve seat insert of the present invention, the matrix phase preferably is a phase having a structure composed of a fine carbide precipitation phase and a tempered martensite phase or a structure composed of a fine carbide precipitation phase, pearlite, a martensite phase, and a high alloy phase. By making a prescribed amount or more of the fine carbide precipitation phase exist in the matrix phase, adhesion of Cu is suppressed during use and the wear resistance of the functional member side layer subjected to copper infiltration treatment is significantly improved. In order to obtain such effects, the functional member side layer in the valve seat insert of the present invention is accounted for by the fine carbide precipitation phase 15% or more, preferably 35% or more, in volume % with respect to the entire matrix phase. The fine carbide precipitation phase is configured to be a phase in which fine carbide has precipitated, specifically a high-speed tool steel composition powder-derived phase that has a Vickers hardness of 450 HV or more. If the fine carbide precipitation phase accounts for less than 15% in volume %, the hardness of the matrix phase is reduced and a desired wear resistance cannot be secured. In order to stably secure improvement in wear resistance by setting the matrix phase hardness to a prescribed value or more, it is more preferable to make the fine carbide precipitation phase account for 35% or more. The matrix phase may be a single phase of a fine carbide precipitation phase, but from the viewpoint of hardness or opposite aggressiveness, the fine carbide precipitation phase preferably accounts for 80% or less in volume % with respect to the entire matrix phase.

If the tempered martensite phase is, or the pearlite, the martensitic phase and the high alloy phase are a phase derived from a pure iron powder composition powder and the tempered martensite phase, or the pearlite, the martensite phase and the high alloy phase account for more than 80% in volume %, the wear resistance of the functional member side layer subjected to copper infiltration treatment is reduced. For this reason, in the present invention, it is preferable to reduce as much as possible the tempered martensite phase, or the pearlite, the martensitic phase and the high alloy phase to less than 80% (including 0%) in volume %.

In addition, the hard particles dispersed in the matrix phase are preferably particles having a Vickers hardness of 600 to 1200 HV. Such hard particles are preferably Co-base intermetallic compound particles. Examples of Co-base intermetallic compound particles include Cr—Mo-type Co-base intermetallic compound particles, Mo—Ni—Cr-type Co-base intermetallic compound particles, and Mo-type Co-base intermetallic compound particles. Besides such Co-base intermetallic compound particles, the hard particles can be exemplified also by Fe—Mo-type particles.

The functional member side layer of the valve seat insert according to the present invention preferably has a structure in which the hard particles are dispersed in the matrix phase in an amount of 10 to 30% in volume % with respect to the entire matrix part of the functional member side layer. If the hard particles to be dispersed account for less than 10% in volume % with respect to the entire matrix part of the functional member side layer, a desired wear resistance cannot be secured. In contrast, if the hard particles are dispersed abundantly exceeding 30%, it will be impossible to secure a desired strength as a valve seat insert. Therefore, the dispersion amount of the hard particles in the functional member side layer is preferably limited to the range of 10 to 30% in volume % with respect to the entire matrix part of the functional member side layer. More preferably, it is 20 to 25%.

In the functional member side layer in the valve seat insert of the present invention, in addition to the above-described hard particles, solid lubricant particles may further be dispersed in an amount of 0.1 to 5.0% in volume % with respect to the entire matrix part of the functional member side layer. If the dispersion amount of solid lubricating particles is less than 0.1%, a desired lubricating effect cannot be expected. On the other hand, if the dispersion amount is more than 5.0%, the machinability improving effect saturates and the strength is reduced. For this reason, in the case of dispersing solid lubricant particles, the amount thereof is preferably limited to 0.1 to 5.0% in volume % with respect to the entire matrix part of the functional member side layer. Examples of the solid lubricant particles include MnS, CaF₂, talc, and MoS₂.

The functional member side layer of the valve seat insert of the present invention except the above-described matrix part structure is pores, which are filled with Cu (copper) or a copper alloy by infiltration.

The Cu infiltration amount in the functional member side layer of the valve seat insert of the present invention is preferably limited to 10% or more and 35% or less in volume % with respect to the entire functional member side layer. If the Cu infiltration amount is less than 10%, thermal conductivity is deteriorated, so that it becomes impossible to secure a desired thermal conductivity. On the other hand, when the Cu infiltration amount is larger than 35%, adhesion wear due to Cu filled in the pores occurs during use and wear resistance is deteriorated. For this reason, the amount of Cu infiltration in the functional member side layer is limited to 10% or more and 35% or less by volume % with respect to the entire functional member side layer. It is preferably in the range of 15 to 30%.

In the functional member side layer in the valve seat insert of the present invention, the composition of the matrix part containing a matrix phase and hard particles or further containing solid lubricant particles is preferably a matrix part composition that contains C: 0.5 to 2.0% in mass % with respect to the entire matrix part, and contains 45% or less in total of one kind or two or more kinds selected from among Co, Mo, Si, Cr, Ni, Mn, W, V, S, Ca, F, Cu and Mg, with the balance being Fe and unavoidable impurities. Hereinafter, mass % in compositions is simply expressed by %.

C: 0.5 to 2.0%

C is an element that increases the strength of valve seat inserts (sintered bodies) and facilitates the diffusion of metal elements during sintering, and it is preferably contained in an amount of 0.5% or more in the functional member side layer of the valve seat insert of the present invention. Meanwhile, when the content exceeds 2.0%, cementite is easily generated in the matrix and a liquid phase is easily generated during sintering, so that dimensional accuracy is reduced. For this reason, it is preferable to limit C in the range of 0.5 to 2.0%. More preferably, the content is 0.75 to 1.75%.

One kind or two or more kinds selected from among Co, Mo, Si, Cr, Ni, Mn, W, V, S, Ca, F, Cu, and Mg: 45% or less in total

All of Co, Mo, Si, Cr, Ni, Mn, W, V, S, Ca, F, Cu, and Mg are elements that increase the strength of valve seat inserts (sintered bodies) and further improve the wear resistance, and one kind or two or more kinds thereof may optionally be contained preferably in a total amount of 10% or more in the matrix phase and the hard particles, or further in the solid lubricant particles. On the other hand, when these elements are contained in a total amount of more than 45%, the moldability is decreased and the radial crushing strength of the valve seat insert is reduced. For this reason, in the functional member side layer, the content of one kind or two or more kinds selected from among Co, Mo, Si, Cr, Ni, Mn, W, V, S, Ca, F, Cu, and Mg is preferably limited to 45% or less in total. More preferably, the content is 35% or less.

In the functional member side layer matrix part, the balance other than the components described above is composed of Fe and unavoidable impurities. In the functional member side layer, the structure other than the above-described matrix part is occupied by pores filled with Cu by copper infiltration treatment, and the infiltrated Cu amount is adjusted to 10 to 35% in volume % with respect to the entire functional member side layer.

On the other hand, the supporting member side layer in the valve seat insert of the present invention is formed of an iron-base sintered alloy like the functional member side layer, and is integrated with the functional member side layer across the boundary by sintering, and has been subjected to copper infiltration treatment and the pores have been filled with Cu.

The supporting member side layer comes into contact with a cylinder head across the seating face, supports the functional member side layer, influences the improvement in thermal conductivity, and contributes to drop of the temperature of the valve seat insert. For this reason, the supporting member side layer in the valve seat insert of the present invention is preferably configured to secure a desired strength and have a desired thermal conductivity.

The supporting member side layer in the valve seat insert of the present invention may have a matrix part structure in which solid lubricant particles are optionally further dispersed in the matrix phase in an amount of 0.1 to 4.0% in volume % with respect to the entire supporting member side layer. If the dispersion amount of solid lubricating particles is less than 0.1%, a desired lubricating effect cannot be expected. On the other hand, if the content exceeds 4.0%, an effect of improving machinability is saturated and the strength is reduced. For this reason, in the case of dispersing solid lubricant particles, it is preferable to limit the amount thereof to 0.1 to 4.0% in volume % with respect to the entire matrix part of the supporting member side layer. Examples of the solid lubricant particles include MnS, CaF₂, talc, and MoS₂.

The supporting member side layer in the valve seat insert of the present invention may have a matrix part structure in which hard particles are optionally further dispersed in the matrix phase in an amount of 4.0% or less in volume % with respect to the entire supporting member side layer. If the dispersed amount of the hard particles is a large amount exceeding 4.0%, the thermal conductivity is excessively deteriorated. For this reason, in the case of dispersing hard particles, it is preferable to limit the amount thereof to 4.0% or less in volume % with respect to the entire matrix part of the supporting member side layer.

The matrix phase composition of the supporting member side layer in the valve seat insert of the present invention is preferably a composition that contains C: 0.5 to 2.0% in mass % with respect to the entire matrix phase of the supporting member side layer or further contains 10% or less in total of one kind or two or more kinds selected from among Mo, Si, Cr, Ni, Mn, W, V, S, Cu and Co, with the balance being Fe and unavoidable impurities. Hereinafter, mass % in compositions is simply expressed by %.

C: 0.5 to 2.0%

C is an element that increases the strength and the hardness of valve seat inserts (sintered bodies), and it is preferably contained in an amount of 0.5% or more in order to secure a desired strength or hardness as the valve seat insert of the present invention. Meanwhile, when the content exceeds 2.0%, cementite is easily generated in the matrix and a liquid phase is easily generated during sintering, so that dimensional accuracy is reduced. For this reason, it is preferable to limit C in the range of 0.5 to 2.0%. More preferably, the content is 0.75 to 1.75%.

The components described above are the basic components of the supporting member side layer, but one kind or two or more kinds selected from among Mo, Si, Cr, Ni, Mn, W, V, S, Cu, and Co may optionally further be contained as selective elements in a total amount of 10% or less as selective elements.

One kind or two or more kinds selected from among Mo, Si, Cr, Ni, Mn, W, V, S, Cu, and Co: 10% or less in total

All of Mo, Si, Cr, Ni, Mn, W, V, S, Cu, and Co are elements that increase the strength and the hardness of the supporting member side layer, and one kind or two or more kinds thereof selected may optionally further be contained. In order to acquire such effects, it is preferable to contain them in a total amount of 10% or less. If the total content of these elements exceeds 10%, the moldability is deteriorated and the strength is also reduced. These elements inhibit thermal conductivity, and therefore, they are preferably contained as little as possible from the viewpoint of improving the thermal conductivity. For this reason, the content thereof is limited to 10% or less in total, if contained.

When solid lubricant particles are dispersed in the matrix phase, the matrix part composition of the supporting member side layer is preferably a matrix part composition containing C: 0.5 to 2.0% in mass % with respect to the entire matrix part and also containing one kind or two or more kinds selected from among Mo, Si, Cr, Ni, Mn, W, V, S, Ca, F, Cu, Co, and Mg in a total amount of 15% or less instead of the above-described matrix phase composition.

In the matrix phase or matrix part of the supporting member side layer in the valve seat insert of the present invention, the balance other than the components described above is composed of Fe and unavoidable impurities.

The supporting member side layer of the valve seat insert of the present invention except the above-described matrix phase or matrix part is occupied by pores, and in the supporting member side layer of the valve seat insert of the present invention, the pores are positively formed and the pores are filled with Cu by copper infiltration treatment, and thus thermal conductivity is improved. In the supporting member side layer in the valve seat insert of the present invention, the Cu infiltration amount is adjusted to 15 to 35% in volume % with respect to the entire supporting member side layer. In the supporting member side layer, if the Cu infiltration amount is less than 15%, a desired heat conductivity cannot be secured. On the other hand, if the Cu infiltration amount is larger than 35%, a desired strength cannot be secured. For this reason, the Cu infiltration amount in the supporting member side layer is limited to the range of 15 to 35% in volume % with respect to the entire supporting member side layer. Preferably, it is 18 to 30%.

Next, a preferable method for producing the valve seat insert of the present invention will be described.

In the present invention, first in a press molding machine, a filling space (a mold) in which a supporting member side layer (a valve seat insert) having a prescribed shape can be formed is formed and the filling space is filled with a raw-material powder (a mixed powder) for a supporting member side layer, and then a filling space (a mold) in which a functional member side layer (a valve seat insert) having a prescribed shape can be formed as an upper layer of the supporting member side layer is formed and the filling space is filled with a raw-material powder (a mixed powder) for the functional member side layer. Furthermore, a filling space (a mold) in which a functional member side layer (a valve seat insert) having a prescribed shape can be formed as an upper layer of the supporting member side layer is formed and the filling space is filled with a raw-material powder (a mixed powder) for the functional member side layer. Then, the supporting member side layer and the functional member side layer are integrally press molded using a commonly used press molding machine to form a green compact (a valve seat insert). From the viewpoint of the strength of a green compact, it is preferable to perform press molding under adjustment such that the resulting green compact has a density of 5.5 to 7.0 g/cm³.

It is not necessary to specifically limit the press molding machine to be used in the present invention, and any press molding machine capable of molding a two-layered valve seat insert can be applied.

As the raw-material powder (the mixed powder) for the supporting member side layer, an iron-based powder, a powder for alloy such as a graphite powder and an alloy element powder, a lubricant particle powder, and optionally a solid lubricant particle powder are blended in prescribed amounts to result in the above-described supporting member side layer composition, mixed, and kneaded to obtain a mixed powder (for the supporting member side layer). The iron-based powder may be a pure iron powder or a steel-based powder with a specific composition.

In addition, as the raw-material powder (the mixed powder) of the functional member side layer, an iron-based powder, a powder for alloy such as a graphite powder and an alloy element powder, a hard particle powder, and optionally a solid lubricant particle powder are blended in prescribed amounts to result in the matrix part composition of the above-described functional member side layer, mixed, and kneaded to obtain a mixed powder (for the functional member side layer). In the present invention, the iron-based powder for forming the matrix phase is preferably a mixture of a steel-based powder having a steel composition capable of forming a fine carbide precipitation phase and a pure iron powder, or a single steel-based powder. In order to maintain the matrix phase hardness high and to suppress the decrease in wear resistance due to Cu adhesion, it is necessary to adjust the proportion of the steel-based powder having a steel composition capable of forming a fine carbide precipitation phase to be high, and it is preferable to limit the use of the pure iron powder as little as possible. Examples of the above-described steel-based powder is a steel-based powder with a high-speed tool steel composition.

Subsequently, the green compact obtained is subjected to sintering treatment to form a sintered body, which is then subjected to processing such as machining to form a valve seat insert (a product) for internal combustion engines. The sintering temperature is preferably adjusted to 1000 to 1300° C. During the sintering treatment or separately from the sintering treatment, copper infiltration treatment is performed to fill pores with copper (Cu) or a copper alloy. In order to impart a desired hardness, heat treatment (quenching and tempering treatment) may be performed.

Hereinafter, the present invention will be further described based on Examples.

### EXAMPLES

As raw-material powders, the raw-material powders shown in Table 1 (an iron-based powder, a powder for alloying elements, a hard particle powder, a solid lubricant particle powder) are blended in the blend amounts shown in Table 1, mixed and kneaded to afford mixed powders for functional member side layers. Further, the raw-material powders (an iron-based powder, a powder for alloying elements, and a solid lubricant particle powder) shown in Table 2 are blended in the blend amounts shown in Table 2, mixed and kneaded to afford mixed powders for supporting member side layers. The compositions of the iron-based powders used are shown in Table 3 and the compositions of the hard particle powders used are shown in Table 4.

TABLE 1

| | For functional member side layer | | | | |
|---|---|---|---|---|---|
| | | Graphite | Alloy element | | Solid lubricant |
| Mixed | Iron-based powder | powder | powder | Hard particle powder | particle powder |
| powder | Type*: blend amount | Blend amount | Type: blend amount | Type**: blend amount | Type***: blend amount |
| No. | (mass %) | (mass %) | (mass %) | (mass %) | (mass %) |
| A | a:10.0, c:62.8 | 1.1 | Ni:1.6, Co: 2.5 | HP2:20.0 | SL1:2.0 |
| B | a:40.0, c:47.1 | 0.9 | — | HP1:10.0 | SL1:2.0 |
| C | a:40.0, c:42.1 | 0.9 | — | HP1:15.0 | SL1:2.0 |
| D | a:40.0, c:37.1 | 0.9 | — | HP1:20.0 | SL1:2.0 |
| E | a:40.0, c:27.1 | 0.9 | — | HP1:30.0 | SL1:2.0 |
| F | a:40.0, c:22.1 | 0.9 | — | HP1:35.0 | SL1:2.0 |
| G | a:15.0, c:61.9 | 1.1 | — | HP1:20.0 | SL1:2.0 |
| H | a:20.0, c:56.9 | 1.1 | — | HP1:20.0 | SL1:2.0 |
| I | a:30.0, c:47.0 | 1.0 | — | HP1:20.0 | SL1:2.0 |
| J | a:50.0, c:27.2 | 0.8 | — | HP1:20.0 | SL1:2.0 |
| K | a:60.0, c:17.2 | 0.8 | — | HP1:20.0 | SL1:2.0 |
| L | a:40.0, c:37.8 | 0.2 | — | HP1:20.0 | SL1:2.0 |
| M | a:40.0, c:37.4 | 0.6 | — | HP1:20.0 | SL1:2.0 |
| N | a:40.0, c:36.6 | 1.4 | — | HP1:20.0 | SL1:2.0 |
| O | a:40.0, c:36.0 | 2.0 | — | HP1:20.0 | SL1:2.0 |
| P | a:40.0, c:39.1 | 0.9 | — | HP1:20.0 | — |
| Q | a:40.0, c:35.1 | 0.9 | — | HP1:20.0 | SL1:4.0 |
| R | a:40.0, d:37.1 | 0.9 | — | HP1:20.0 | SL1:2.0 |
| S | b:40.0, c:37.1 | 0.9 | — | HP1:20.0 | SL1:2.0 |
| T | a:40.0, c:37.1 | 0.9 | — | HP2:20.0 | SL1:2.0 |
| U | a:40.0, c:37.1 | 0.9 | — | HP3:20.0 | SL1:2.0 |
| V | a:40.0, c:37.1 | 0.9 | — | HP1:20.0 | SL2:2.0 |
| W | a:40.0, c:34.6 | 0.9 | Co:2.5 | HP1:20.0 | SL1:2.0 |
| X | a:40.0, c:32.1 | 0.9 | Cu:5.0 | HP1:20.0 | SL1:2.0 |

*See Table 3
**See Table 4
***SL1:MnS, SL2:CaF₂

TABLE 2

| | For supporting member side layer | | | | |
|---|---|---|---|---|---|
| | | Graphite | | | Solid lubricant particle |
| Mixed | Iron-based powder | powder | Alloy element powder | Hard particle powder | powder |
| powder | Type*: blend amount | Blend amount | Type: blend amount | Type**: blend amount | Type***: blend amount |
| No. | (mass %) | (mass %) | (mass %) | (mass %) | (mass %) |
| 1A | c:95.25 | 0.92 | Ni:0.33, Co: 2.71 | HP4:0.79 | — |
| 1B | d:98.8 | 1.1 | — | — | SL1:0.1 |
| 1C | d:97.9 | 1.1 | — | — | SL1:1.0 |
| 1D | d:95.9 | 1.1 | — | — | SL1:3.0 |
| 1E | c:97.9 | 1.1 | — | — | SL1:1.0 |
| 1F | a:1.0, d: 96.9 | 1.1 | — | — | SL1:1.0 |
| 1G | d:96.9 | 1.1 | — | HP1:1.0 | SL1:1.0 |
| 1H | d:97.9 | 1.1 | — | — | SL2:1.0 |
| 1I | d:92.9 | 1.1 | Cu:5.0 | — | SL1:1.0 |
| 1J | d:98.9 | 1.1 | — | — | — |

*See Table 3
**See Table 4
***SL1:MnS, SL2:CaF₂

TABLE 3

| Iron-based | Chemical composition (mass %) | | | | | | | | | | | |
|---|---|---|---|---|---|---|---|---|---|---|---|---|
| powder No. | C | Si | Mn | Cr | Ni | Mo | Co | V | W | Others | Balance | Remarks |
| a | 0.90 | 0.30 | 0.20 | 4.10 | — | 4.90 | — | 2.00 | 5.80 | 0.10 | Fe | High-speed tool steel powder 1 |
| b | 1.21 | 0.23 | 0.27 | 4.12 | 0.15 | 3.56 | 9.39 | 3.38 | 9.14 | 0.10 | Fe | High-speed tool steel powder 2 |
| c | 0.02 | — | — | — | — | — | — | — | — | 0.25 | Fe | Atomized powder |
| d | 0.02 | — | — | — | — | — | — | — | — | 0.20 | Fe | Reduced iron powder |

*)a: High-speed tool steel powder 1,
b: high-speed tool steel powder 2,
c: pure iron powder (atomized powder),
d: reduced iron powder

TABLE 4

| Hard | Chemical composition (mass %) | | | | | | |
|---|---|---|---|---|---|---|---|
| particle No. | Mo | Ni | Cr | Co | Fe | Others | Remarks |
| HP1 | 28 | — | 9 | Bal. | — | 5% or less | Cr—Mo-type Co-base intermetallic compound powder |
| HP2 | 24 | 10 | 24 | Bal. | — | 5% or less | Mo—Ni—Cr-type Co-base intermetallic compound powder |
| HP3 | 45 | — | 5% or less | Bal. | 10 | 5% or less | Mo-type Co-base intermetallic compound powder |
| HP4 | 60 | — | — | — | Bal | 5% or less | Fe—Mo-type hard particle powder |

Next, these mixed powders were integrally press molded (at a face pressure: 2 to 7 ton/cm²) with a press molding machine, and thus two-layered green compacts for valve seat inserts were obtained.

The green compacts obtained were further subjected to a 1P1S step of sintering treatment (heating temperature: 1000 to 1300° C.) to afford sintered bodies. In the sintering, copper infiltration treatment was performed, so that Cu was filled (infiltrated) into pores. Infiltration treatment was not applied to the sintered body No. 1 (Conventional Example).

Subsequently, the sintered bodies obtained were subjected to heat treatment (900° C. heating-quenching treatment and 600° C. tempering treatment), followed by machining and grinding to afford valve seat inserts (products) with an outer diameter of 27.1 mm, an inner diameter of 22.0 mm, and a thickness of 6.5 mm. The above-described heat treatment was not applied to some of the sintered bodies and those which were not subjected to the infiltration treatment.

For each of the layers of the valve seat inserts (the products) obtained, the contents of the respective compositions were analyzed by emission analysis, and thus the composition of each layer was measured. Further, the Cu (infiltration) amount (mass %) in each layer was calculated from the Cu amount in the layer determined by emission analysis. The obtained results are shown in Table 5.

TABLE 5

| | Mixed powder No. | | | Sintered body chemical composition (mass %) | | | | | | | | | | | | |
|---|---|---|---|---|---|---|---|---|---|---|---|---|---|---|---|---|
| | Functional | Supporting | | Functional member side layer | | | | | | | | | | | | |
| Sintered | member | member | Thermal | | Others | | | | | | | | | | | |
| body No. | side layer | side layer | treatment | C | Co | Si | Ca | Ni | Mo | Cr | Mn | S | W | V | Cu | Total |
| 1 | A | 1A | No | 1.10 | 10.51 | — | — | 3.61 | 5.29 | 5.21 | 1.22 | 0.8 | 0.58 | 0.2 | — | 28.52 |
| 2 | B | 1C | Yes | 1.27 | 5.95 | 0.41 | — | — | 4.86 | 2.48 | 1.46 | 0.70 | 2.41 | 0.80 | — | 20.34 |
| 3 | C | 1C | Yes | 1.28 | 8.92 | 0.53 | — | — | 6.24 | 2.88 | 1.44 | 0.71 | 2.40 | 0.81 | — | 25.21 |
| 4 | D | 1C | Yes | 1.26 | 11.93 | 0.66 | — | — | 7.64 | 3.28 | 1.43 | 0.72 | 2.40 | 0.80 | — | 30.12 |
| 5 | D | 1C | No | 1.26 | 11.89 | 0.68 | — | — | 7.63 | 3.25 | 1.43 | 0.72 | 2.41 | 0.81 | — | 30.08 |
| 6 | E | 1C | Yes | 1.27 | 17.85 | 0.91 | — | — | 10.40 | 4.08 | 1.47 | 0.71 | 2.39 | 0.83 | — | 39.91 |
| 7 | F | 1C | Yes | 1.26 | 20.82 | 1.03 | — | — | 11.85 | 4.48 | 1.46 | 0.74 | 2.40 | 0.79 | — | 44.83 |
| 8 | G | 1C | Yes | 1.25 | 11.89 | 0.56 | — | — | 6.35 | 2.23 | 1.35 | 0.73 | 2.38 | 0.80 | — | 27.54 |
| 9 | H | 1C | Yes | 1.29 | 11.95 | 0.58 | — | — | 6.61 | 2.44 | 1.37 | 0.72 | 1.20 | 0.41 | — | 26.57 |
| 10 | I | 1C | Yes | 1.28 | 11.80 | 0.62 | — | — | 7.11 | 2.86 | 1.44 | 0.73 | 1.81 | 0.61 | — | 28.26 |
| 11 | J | 1C | Yes | 1.27 | 12.00 | 0.70 | — | — | 8.16 | 3.76 | 1.52 | 0.69 | 3.05 | 1.00 | — | 32.15 |
| 12 | K | 1C | Yes | 1.34 | 11.98 | 0.74 | — | — | 8.62 | 4.12 | 1.56 | 0.69 | 3.72 | 1.20 | — | 33.97 |
| 13 | L | 1C | Yes | 0.67 | 11.91 | 0.68 | — | — | 7.65 | 3.28 | 1.44 | 0.70 | 2.43 | 0.81 | — | 29.57 |
| 14 | M | 1C | Yes | 0.97 | 11.95 | 0.69 | — | — | 7.62 | 3.25 | 1.47 | 0.73 | 2.45 | 0.79 | — | 29.92 |
| 15 | N | 1C | Yes | 1.77 | 11.93 | 0.66 | — | — | 7.60 | 3.26 | 1.44 | 0.68 | 2.38 | 0.78 | — | 30.50 |
| 16 | O | 1C | Yes | 2.37 | 11.98 | 0.66 | — | — | 7.60 | 3.25 | 1.43 | 0.73 | 2.40 | 0.80 | — | 31.22 |
| 17 | P | 1C | Yes | 1.28 | 11.92 | 0.67 | — | — | 7.61 | 3.27 | 0.18 | — | 2.37 | 0.79 | — | 28.09 |
| 18 | Q | 1C | Yes | 1.27 | 11.89 | 0.64 | — | — | 7.62 | 3.29 | 4.07 | 2.12 | 2.45 | 0.83 | — | 34.18 |
| 19 | R | 1C | Yes | 1.27 | 11.95 | 0.65 | — | — | 7.61 | 3.34 | 1.45 | 0.74 | 2.41 | 0.81 | — | 30.23 |
| 20 | S | 1C | Yes | 1.26 | 11.98 | 0.67 | — | — | 7.63 | 3.26 | 1.45 | 0.74 | 2.40 | 0.82 | — | 30.21 |
| 21 | T | 1C | Yes | 1.27 | 7.65 | 0.74 | — | — | 10.90 | 2.48 | 1.46 | 0.73 | 2.40 | 0.80 | — | 28.43 |
| 22 | U | 1C | Yes | 1.26 | — | 0.16 | — | — | 14.00 | 1.68 | 1.46 | 0.70 | 2.40 | 0.80 | — | 22.46 |
| 23 | V | 1C | Yes | 1.27 | 11.92 | 0.68 | 2.16 | — | 7.62 | 3.28 | — | — | 2.43 | 0.78 | — | 30.14 |
| 24 | W | 1C | Yes | 1.27 | 14.42 | 0.67 | — | — | 7.58 | 3.28 | 1.49 | 0.69 | 2.39 | 0.78 | — | 32.57 |
| 25 | X | 1C | Yes | 1.27 | 11.92 | 0.66 | — | — | 7.59 | 3.30 | 1.48 | 0.67 | 2.43 | 0.81 | 5.01 | 35.14 |
| 26 | D | 1B | Yes | 1.26 | 11.91 | 0.68 | — | — | 7.57 | 3.31 | 1.49 | 0.73 | 2.42 | 0.82 | — | 30.19 |
| 27 | D | 1D | Yes | 1.28 | 11.90 | 0.68 | — | — | 7.60 | 3.28 | 1.43 | 0.72 | 2.43 | 0.79 | — | 30.11 |
| 28 | D | 1E | Yes | 1.27 | 11.94 | 0.69 | — | — | 7.60 | 3.29 | 1.45 | 0.72 | 2.37 | 0.80 | — | 30.13 |
| 29 | D | 1F | Yes | 1.26 | 11.92 | 0.63 | — | — | 7.61 | 3.30 | 1.42 | 0.70 | 2.38 | 0.80 | — | 30.02 |
| 30 | D | 1G | Yes | 1.26 | 11.89 | 0.66 | — | — | 7.58 | 3.30 | 1.45 | 0.68 | 2.37 | 0.79 | — | 29.98 |
| 31 | D | 1H | Yes | 1.26 | 11.87 | 0.67 | — | — | 7.59 | 3.28 | 1.42 | 0.69 | 2.39 | 0.82 | — | 29.99 |
| 32 | D | 1I | Yes | 1.25 | 11.94 | 0.68 | — | — | 7.60 | 3.29 | 1.43 | 0.71 | 2.41 | 0.79 | — | 30.10 |
| 33 | D | 1J | Yes | 1.26 | 11.89 | 0.68 | — | — | 7.59 | 3.30 | 1.42 | 0.70 | 2.38 | 0.80 | — | 30.02 |
| 34 | D | 1C | Yes | 1.26 | 11.85 | 0.67 | — | — | 7.62 | 3.28 | 1.49 | 0.73 | 2.43 | 0.83 | — | 30.16 |
| 35 | D | 1C | Yes | 1.26 | 11.87 | 0.67 | — | — | 7.62 | 3.26 | 1.48 | 0.73 | 2.43 | 0.83 | — | 30.15 |
| 36 | D | 1C | Yes | 1.28 | 11.88 | 0.68 | — | — | 7.61 | 3.28 | 1.48 | 0.74 | 2.40 | 0.80 | — | 30.15 |
| 37 | D | 1C | Yes | 1.26 | 11.91 | 0.67 | — | — | 7.63 | 3.30 | 1.49 | 0.69 | 2.40 | 0.81 | — | 30.16 |
| 38 | D | 1C | Yes | 1.27 | 11.93 | 0.66 | — | — | 7.58 | 3.27 | 1.48 | 0.67 | 2.41 | 0.82 | — | 30.09 |
| 39 | D | 1C | Yes | 1.27 | 11.86 | 0.66 | — | — | 7.58 | 3.27 | 1.49 | 0.68 | 2.41 | 0.81 | — | 30.03 |

| | Sintered body chemical composition (mass %) | | | | | | | |
|---|---|---|---|---|---|---|---|---|
| | | | Supporting member side layer | | | | | |
| | Functional member side layer | | | Others | | | | |
| Sintered | | Cu | | Mo, Si, Cr, Ni, | | | Cu | |
| body No. | Balance | (Infiltration) | C | Mn, W, V, S | Total | Balance | (Infiltration) | Remarks |
| 1 | Fe | — | 1.20 | Mo: 0.62, Cu: 4.01 | 4.63 | Fe | — | Conventional Example |
| 2 | Fe | 16.02 | 1.12 | Mn: 0.65, S: 0.35 | 1.00 | Fe | 19.21 | Comparative Example |
| 3 | Fe | 15.82 | 1.12 | Mn: 0.66, S: 0.34 | 1.00 | Fe | 19.32 | Inventive Example |
| 4 | Fe | 15.96 | 1.13 | Mn: 0.64, S: 0.35 | 0.99 | Fe | 19.34 | Inventive Example |
| 5 | Fe | 15.86 | 1.14 | Mn: 0.65, S: 0.35 | 1.00 | Fe | 19.39 | Inventive Example |
| 6 | Fe | 15.60 | 1.12 | Mn: 0.65, S: 0.35 | 1.00 | Fe | 19.50 | Inventive Example |
| 7 | Fe | 15.82 | 1.12 | Mn: 0.66, S: 0.34 | 1.00 | Fe | 19.03 | Inventive Example |
| 8 | Fe | 16.09 | 1.11 | Mn: 0.66, S: 0.35 | 1.01 | Fe | 18.96 | Comparative Example |
| 9 | Fe | 16.12 | 1.12 | Mn: 0.65, S: 0.36 | 1.01 | Fe | 19.30 | Inventive Example |
| 10 | Fe | 15.98 | 1.13 | Mn: 0.64, S: 0.35 | 0.99 | Fe | 19.46 | Inventive Example |
| 11 | Fe | 15.92 | 1.12 | Mn: 0.65, S: 0.36 | 1.01 | Fe | 19.24 | Inventive Example |
| 12 | Fe | 15.83 | 1.14 | Mn: 0.66, S: 0.34 | 1.00 | Fe | 18.93 | Inventive Example |
| 13 | Fe | 16.32 | 1.13 | Mn: 0.64, S: 0.35 | 0.99 | Fe | 19.30 | Inventive Example |
| 14 | Fe | 16.20 | 1.13 | Mn: 0.66, S: 0.35 | 1.01 | Fe | 19.50 | Inventive Example |
| 15 | Fe | 16.03 | 1.12 | Mn: 0.65, S: 0.34 | 0.99 | Fe | 19.32 | Inventive Example |
| 16 | Fe | 16.05 | 1.14 | Mn: 0.64, S: 0.34 | 0.98 | Fe | 19.56 | Inventive Example |
| 17 | Fe | 15.91 | 1.13 | Mn: 0.66, S: 0.36 | 1.02 | Fe | 18.86 | Inventive Example |
| 18 | Fe | 16.09 | 1.12 | Mn: 0.65, S: 0.36 | 1.01 | Fe | 19.21 | Inventive Example |
| 19 | Fe | 15.87 | 1.14 | Mn: 0.65, S: 0.35 | 1.00 | Fe | 19.03 | Inventive Example |
| 20 | Fe | 16.08 | 1.12 | Mn: 0.66, S: 0.35 | 1.01 | Fe | 18.98 | Inventive Example |
| 21 | Fe | 15.99 | 1.13 | Mn: 0.66, S: 0.35 | 1.01 | Fe | 18.97 | Inventive Example |
| 22 | Fe | 16.02 | 1.12 | Mn: 0.65, S: 0.34 | 0.99 | Fe | 19.32 | Inventive Example |
| 23 | Fe | 16.20 | 1.12 | Mn: 0.65, S: 0.36 | 1.01 | Fe | 19.29 | Inventive Example |
| 24 | Fe | 15.89 | 1.14 | Mn: 0.64, S: 0.36 | 1.00 | Fe | 19.25 | Inventive Example |
| 25 | Fe | 20.96 | 1.11 | Mn: 0.66, S: 0.35 | 1.01 | Fe | 19.60 | Inventive Example |
| 26 | Fe | 16.02 | 1.12 | Mn: 0.062, S: 0.032 | 0.094 | Fe | 19.45 | Inventive Example |
| 27 | Fe | 15.96 | 1.13 | Mn: 1.97, S: 1.06 | 3.03 | Fe | 19.23 | Inventive Example |
| 28 | Fe | 15.97 | 1.12 | Mn: 0.64, S: 0.37 | 1.01 | Fe | 18.96 | Inventive Example |
| 29 | Fe | 16.03 | 1.13 | Mn: 0.64, S: 0.35, V: 0.02, W: 0.06 | 1.07 | Fe | 19.23 | Inventive Example |
| 30 | Fe | 15.87 | 1.14 | Mn: 0.65, S: 0.35, Mo: 0.28, Cr: 0.08 | 1.36 | Fe | 19.30 | Inventive Example |
| 31 | Fe | 15.98 | 1.13 | Ca: 1.0 | 1.00 | Fe | 19.23 | Inventive Example |
| 32 | Fe | 16.01 | 1.12 | Cu: 5.04, Mn: 0.65, S: 0.36 | 6.05 | Fe | 25.87 | Inventive Example |
| 33 | Fe | 15.93 | 1.13 | — | — | Fe | 19.24 | Inventive Example |
| 34 | Fe | 12.34 | 1.12 | Mn: 0.66, S: 0.35 | 1.01 | Fe | 16.32 | Comparative Example |
| 35 | Fe | 18.26 | 1.12 | Mn: 0.66, S: 0.35 | 1.01 | Fe | 20.86 | Inventive Example |
| 36 | Fe | 24.62 | 1.13 | Mn: 0.65, S: 0.36 | 1.01 | Fe | 22.13 | Inventive Example |
| 37 | Fe | 27.29 | 1.12 | Mn: 0.66, S: 0.34 | 1.00 | Fe | 26.80 | Inventive Example |
| 38 | Fe | 33.43 | 1.12 | Mn: 0.65, S: 0.33 | 0.98 | Fe | 31.45 | Inventive Example |
| 39 | Fe | 45.73 | 1.13 | Mn: 0.64, S: 0.33 | 0.97 | Fe | 43.45 | Comparative Example |

Further, the cross sections of the obtained valve seat inserts (the products) were ground and subjected to nital etching, and the structure of each layer was observed using a scanning electron microscope (magnification: 200×) and the structure of each layer was imaged. From the structure photograph obtained, the structure fraction in each layer was calculated by image analysis, and the result is shown in Table 6. It is noted that the fraction other than the structure fraction shown in the table is occupied by pores. The amount of hard particles dispersed in a matrix phase of a functional member side layer and the amount of solid lubricant particles were shown in volume % with respect to the entire matrix part of a functional member. Further, the amount of solid lubricant particles dispersed in a matrix phase of a supporting member side layer was shown in volume % with respect to the entire matrix part of a supporting member. In addition, the Cu (infiltration) amount was shown in volume % with respect to each entire layer.

TABLE 6

| | | | | Sintered body structure (volume %) | | | | | | | | |
|---|---|---|---|---|---|---|---|---|---|---|---|---|
| | | | | Functional member | | | | | | | | |
| | | | | side layer | | | | | | | | |
| | | | | Matrix phase | | | | | | | | |
| | | | | (volume %) | | | | | | | | |
| | | | | | Tempered martensite | | | | | | | |
| | Mixed powder No. | | | Fine | phase, etc. | | | | | | | Solid |
| Sintered | Functional | Supporting | | carbide | Tempered | | | High | | | Hard | lubricant |
| body | member | member | Thermal | precipitation | martensite | Pearl- | Martensite | alloy | | | particle | particle |
| No. | side layer | side layer | treatment | phase | phase | ite | phase | phase | Others | Total | (volume %) | (volume %) |
| 1 | A | 1A | No | 9.4 | — | 55.4 | — | — | 3.0 | 58.4 | 16.0 | 2.6 |
| 2 | B | 1C | Yes | 37.6 | 36.5 | — | — | — | 2.0 | 38.5 | 7.2 | 2.5 |
| 3 | C | 1C | Yes | 37.3 | 29.7 | — | — | — | 3.5 | 33.2 | 11.8 | 2.8 |
| 4 | D | 1C | Yes | 38.7 | 25.6 | — | — | — | 3.1 | 28.6 | 14.5 | 2.6 |
| 5 | D | 1C | No | 35.3 | — | 19.1 | 1.6 | 4.9 | 1.2 | 26.8 | 21.7 | 2.6 |
| 6 | E | 1C | Yes | 36.1 | 19.6 | — | — | — | 2.3 | 21.9 | 25.4 | 2.3 |
| 7 | F | 1C | Yes | 35.7 | 16.2 | — | — | — | 2.5 | 18.7 | 29.8 | 2.7 |
| 8 | G | 1C | Yes | 13.1 | 51.1 | — | — | — | 3.5 | 54.6 | 15.1 | 2.6 |
| 9 | H | 1C | Yes | 17.5 | 46.0 | — | — | — | 1.9 | 47.9 | 14.7 | 2.4 |
| 10 | I | 1C | Yes | 26.3 | 38.8 | — | — | — | 2.0 | 40.8 | 14.1 | 2.1 |
| 11 | J | 1C | Yes | 43.9 | 22.4 | — | — | — | 3.6 | 26.0 | 13.8 | 2.3 |
| 12 | K | 1C | Yes | 52.7 | 14.2 | — | — | — | 2.1 | 16.3 | 13.9 | 2.2 |
| 13 | L | 1C | Yes | 36.2 | 27.8 | — | — | — | 2.1 | 29.9 | 14.2 | 2.5 |
| 14 | M | 1C | Yes | 36.3 | 26.3 | — | — | — | 1.7 | 28.0 | 14.7 | 2.8 |
| 15 | N | 1C | Yes | 37.5 | 25.2 | — | — | — | 3.0 | 28.2 | 13.9 | 3.0 |
| 16 | O | 1C | Yes | 37.1 | 26.7 | — | — | — | 2.9 | 29.6 | 14.1 | 2.4 |
| 17 | P | 1C | Yes | 36.9 | 28.2 | — | — | — | 2.4 | 30.6 | 14.1 | — |
| 18 | Q | 1C | Yes | 36.8 | 23.9 | — | — | — | 2.1 | 26.0 | 15.2 | 4.7 |
| 19 | R | 1C | Yes | 37.4 | 25.6 | — | — | — | 2.3 | 27.9 | 15.1 | 2.5 |
| 20 | S | 1C | Yes | 36.5 | 26.1 | — | — | — | 3.1 | 29.2 | 14.9 | 2.6 |
| 21 | T | 1C | Yes | 35.9 | 25.6 | — | — | — | 2.8 | 28.4 | 15.0 | 2.8 |
| 22 | U | 1C | Yes | 36.1 | 26.1 | — | — | — | 2.5 | 28.6 | 14.8 | 2.5 |
| 23 | V | 1C | Yes | 36.6 | 25.3 | — | — | — | 3.1 | 28.4 | 14.8 | 2.8 |
| 24 | W | 1C | Yes | 37.5 | 24.5 | — | — | — | 2.8 | 27.3 | 14.6 | 2.4 |
| 25 | X | 1C | Yes | 37.8 | 25.5 | — | — | — | 3.4 | 28.9 | 14.5 | 2.6 |
| 26 | D | 1B | Yes | 37.6 | 27.1 | — | — | — | 3.2 | 30.3 | 13.6 | 2.1 |
| 27 | D | 1D | Yes | 36.8 | 28.2 | — | — | — | 3.3 | 31.5 | 13.9 | 2.6 |
| 28 | D | 1E | Yes | 36.5 | 28.1 | — | — | — | 3.3 | 31.4 | 14.3 | 2.4 |
| 29 | D | 1F | Yes | 37.4 | 26.7 | — | — | — | 3.4 | 30.1 | 14.2 | 2.3 |
| 30 | D | 1G | Yes | 36.2 | 27.2 | — | — | — | 3.1 | 30.3 | 14.2 | 2.9 |
| 31 | D | 1H | Yes | 37.6 | 25.6 | — | — | — | 2.5 | 28.1 | 14.7 | 2.7 |
| 32 | D | 1I | Yes | 36.2 | 28.5 | — | — | — | 2.4 | 30.9 | 14.4 | 2.5 |
| 33 | D | 1J | Yes | 37.2 | 28.2 | — | — | — | 2.9 | 31.1 | 14.5 | 2.9 |
| 34 | D | 1C | Yes | 37.5 | 29.2 | — | — | — | 3.6 | 32.8 | 14.9 | 3.2 |
| 35 | D | 1C | Yes | 35.4 | 26.2 | — | — | — | 2.4 | 28.6 | 14.3 | 2.5 |
| 36 | D | 1C | Yes | 33.6 | 24.3 | — | — | — | 1.9 | 26.2 | 13.8 | 2.1 |
| 37 | D | 1C | Yes | 31.8 | 22.2 | — | — | — | 3.5 | 35.7 | 12.5 | 2.6 |
| 38 | D | 1C | Yes | 29.6 | 20.7 | — | — | — | 2.5 | 23.2 | 11.9 | 2.7 |
| 39 | D | 1C | Yes | 26.1 | 19.8 | — | — | — | 1.3 | 21.1 | 9.3 | 3.1 |

| | Sintered body structure (volume %) | | | | | | | | |
|---|---|---|---|---|---|---|---|---|---|
| | | Supporting member | | | | | | | |
| | | side layer | | | | | | | |
| | | Matrix phase | | | | | | | |
| | Functional member | (volume %) | | | | | | | |
| | side layer | Tempered martensite | | | | | | | |
| | Cu | phase, etc. | | | | | Solid | Cu | |
| Sintered | infiltration | Tempered | | | | | lubricant | infiltration | |
| body | amount | martensite | Pearl- | Martensite | | | particle | amount | |
| No. | (volume %) | phase | ite | phase | Others | Total | (volume %) | (volume %) | Remarks |
| 1 | — | — | 76.2 | — | 2.5 | 78.7 | — | — | Conventional Example |
| 2 | 13.5 | 78.4 | — | — | 3.2 | 81.6 | 1.2 | 16.5 | Comparative Example |
| 3 | 14.2 | 76.9 | — | — | 3.5 | 80.4 | 1.2 | 17.1 | Inventive Example |
| 4 | 14.9 | 75.6 | — | — | 2.5 | 78.1 | 1.0 | 19.4 | Inventive Example |
| 5 | 11.9 | — | 73.8 | 4.5 | 2.3 | 80.6 | 0.9 | 17.5 | Inventive Example |
| 6 | 12.9 | 76.5 | — | — | 2.1 | 78.6 | 1.3 | 19.1 | Inventive Example |
| 7 | 12.5 | 78.1 | — | — | 2.4 | 80.5 | 1.4 | 17.5 | Inventive Example |
| 8 | 13.1 | 76.3 | — | — | 2.1 | 78.4 | 0.9 | 18.4 | Comparative Example |
| 9 | 15.4 | 76.8 | — | — | 2.1 | 78.9 | 1.0 | 18.7 | Inventive Example |
| 10 | 14.1 | 77.2 | — | — | 2.9 | 80.1 | 1.0 | 17.6 | Inventive Example |
| 11 | 13.0 | 76.9 | — | — | 2.6 | 79.1 | 1.1 | 17.5 | Inventive Example |
| 12 | 14.1 | 78.3 | — | — | 2.3 | 80.6 | 1.3 | 16.5 | Inventive Example |
| 13 | 15.2 | 77.6 | — | — | 3.0 | 80.6 | 1.2 | 17.5 | inventive Example |
| 14 | 15.4 | 78.4 | — | — | 1.9 | 80.3 | 1.5 | 16.9 | Inventive Example |
| 15 | 15.1 | 77.3 | — | — | 2.1 | 79.4 | 1.0 | 17.9 | Inventive Example |
| 16 | 15.7 | 78.5 | — | — | 2.2 | 80.7 | 1.3 | 16.7 | Inventive Example |
| 17 | 15.7 | 78.6 | — | — | 2.3 | 80.9 | 1.2 | 17.4 | Inventive Example |
| 18 | 15.4 | 77.3 | — | — | 3.1 | 80.4 | 1.1 | 17.9 | Inventive Example |
| 19 | 14.7 | 77.6 | — | — | 3.0 | 80.6 | 1.2 | 16.9 | Inventive Example |
| 20 | 15.0 | 77.9 | — | — | 2.6 | 80.5 | 1.4 | 17.6 | Inventive Example |
| 21 | 14.5 | 78.2 | — | — | 2.8 | 81.0 | 1.3 | 16.9 | Inventive Example |
| 22 | 15.5 | 78.1 | — | — | 2.7 | 80.8 | 1.0 | 17.4 | Inventive Example |
| 23 | 14.4 | 75.4 | — | — | 2.5 | 77.9 | 1.2 | 18.4 | Inventive Example |
| 24 | 14.3 | 76.8 | — | — | 2.4 | 79.2 | 1.2 | 17.8 | Inventive Example |
| 25 | 14.7 | 76.3 | — | — | 2.6 | 78.9 | 1.0 | 18.4 | Inventive Example |
| 26 | 15.2 | 77.5 | — | — | 2.9 | 80.4 | 0.1 | 18.5 | Inventive Example |
| 27 | 14.2 | 76.4 | — | — | 3.0 | 79.4 | 3.3 | 16.7 | Inventive Example |
| 28 | 14.2 | 76.6 | — | — | 2.6 | 79.2 | 1.2 | 17.8 | Inventive Example |
| 29 | 15.4 | 75.2 | — | — | 3.5 | 78.7 | 1.0 | 18.4 | Inventive Example |
| 30 | 15.2 | 74.3 | — | — | 3.8 | 78 | 1.3 | 18.7 | Inventive Example |
| 31 | 15.4 | 77.8 | — | — | 2.3 | 80.1 | 1.3 | 17.4 | Inventive Example |
| 32 | 14.9 | 77.4 | — | — | 2.8 | 80.2 | 1.1 | 18.0 | Inventive Example |
| 33 | 15.3 | 76.3 | — | — | 2.8 | 79.1 | — | 17.9 | Inventive Example |
| 34 | 9.3 | 79.8 | — | — | 2.8 | 82.6 | 1.2 | 14.3 | Comparative Example |
| 35 | 17.9 | 75.6 | — | — | 2.6 | 78.2 | 1.2 | 19.1 | Inventive Example |
| 36 | 23.5 | 74.5 | — | — | 2.3 | 76.8 | 1.1 | 20.7 | Inventive Example |
| 37 | 26.0 | 71.3 | — | — | 2.3 | 73.6 | 1.2 | 24.1 | Inventive Example |
| 38 | 31.2 | 62.6 | — | — | 2.4 | 65.0 | 1.3 | 30.5 | Inventive Example |
| 39 | 39.8 | 57.3 | — | — | 2.1 | 59.4 | 1.0 | 37.8 | Comparative Example |

Further, the cross sections of the obtained valve seat inserts (the products) were ground and subjected to nital etching, and the structure was observed using an optical microscope (magnification: 200×) and the proportion (volume %) of the functional member side layer in the valve seat insert was determined and shown in Table 7.

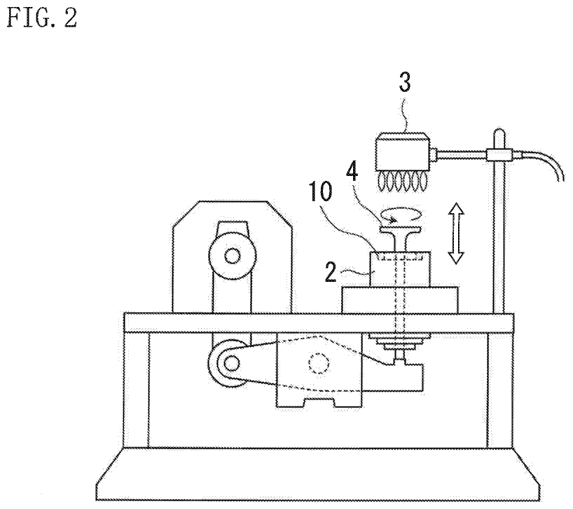

Next, using the valve seat inserts (the products) obtained as test pieces, they were mounted on a single rig wear testing machine shown in FIG. 2 and a wear test was performed under the following conditions:

Test temperature: 270° C.,

Test time: 8 hours,

Cam rotation speed: 3000 rpm,

Valve speed: 20 rpm,

Valve material: nitride valve,

Heat source: LPG.

The difference between before and after the wear test was calculated from the shape of a test piece (a valve seat insert) before and after the test and converted into a wear amount (μm). Taking the wear amount of the sintered body No. 1 (Conventional Example) as 1.00 (standard), the wear ratio of each valve seat insert to that is calculated, and the results are shown in Table 7. Cases where the valve seat insert wear ratio was equal to or less than that of the conventional example were evaluated as “o”, and other cases were evaluated as “x”.

Further, a sample for thermal conductivity rate measurement was prepared under the same conditions as those for the above-described valve seat insert, and the thermal conductivity rate thereof at 300° C. was measured using a laser flash method and is shown in Table 7. Cases where the thermal conductivity rate at 300° C. satisfies 25 W/m·K or more in the functional member side layer, 60 W/m·K or more in the supporting member side layer, and 45 W/m·K or more in the entire valve seat insert (average) are evaluates as “o”, and the other cases were evaluated as “x”.

TABLE 7

| | | | | | Thermal conductivity | | | | | | |
|---|---|---|---|---|---|---|---|---|---|---|---|
| | Mixed powder No. | | | Func- | Func- | | | | | | |
| | Func- | | | tional | tional | Supporting | | | Wear | | |
| Sintered | tional | Supporting | Thermal | member | member | member | | | resistance | | |
| body | member | member | treat- | side layer | side layer | side layer | Entirety | Evalu- | Wear | Evalu- | |
| No. | side layer | side layer | ment | ratio (%) | (W/m · K) | (W/m · K) | (W/m · K) | ation | ratio | ation | Remarks |
| 1 | A | 1A | No | 40.80 | 13.20 | 24.02 | 19.61 | X | 1.00 | Standard | Conventional Example |
| 2 | B | 1C | Yes | 35.62 | 26.78 | 62.60 | 49.84 | ◯ | 1.15 | X | Comparative Example |
| 3 | C | 1C | Yes | 30.30 | 28.80 | 64.20 | 53.47 | ◯ | 0.98 | ◯ | Inventive Example |
| 4 | D | 1C | Yes | 29.23 | 28.80 | 64.30 | 53.92 | ◯ | 0.92 | ◯ | Inventive Example |
| 5 | D | 1C | No | 32.32 | 28.87 | 64.56 | 53.02 | ◯ | 0.97 | ◯ | Inventive Example |
| 6 | E | 1C | Yes | 32.02 | 29.20 | 66.20 | 54.35 | ◯ | 0.69 | ◯ | Inventive Example |
| 7 | F | 1C | Yes | 31.53 | 27.25 | 65.21 | 53.24 | ◯ | 0.57 | ◯ | Inventive Example |
| 8 | G | 1C | Yes | 25.94 | 28.20 | 62.31 | 53.46 | ◯ | 1.09 | X | Comparative Example |
| 9 | H | 1C | Yes | 31.12 | 27.98 | 65.34 | 53.71 | ◯ | 0.97 | ◯ | Inventive Example |
| 10 | I | 1C | Yes | 26.32 | 28.31 | 69.20 | 58.44 | ◯ | 0.94 | ◯ | Inventive Example |
| 11 | J | 1C | Yes | 28.21 | 27.58 | 63.20 | 53.15 | ◯ | 0.9 | ◯ | Inventive Example |
| 12 | K | 1C | Yes | 27.38 | 28.65 | 64.32 | 54.55 | ◯ | 0.83 | ◯ | Inventive Example |
| 13 | L | 1C | Yes | 32.03 | 29.20 | 65.86 | 54.12 | ◯ | 0.98 | ◯ | Inventive Example |
| 14 | M | 1C | Yes | 30.68 | 29.84 | 64.50 | 53.87 | ◯ | 0.94 | ◯ | Inventive Example |
| 15 | N | 1C | Yes | 29.13 | 30.80 | 65.31 | 55.26 | ◯ | 0.91 | ◯ | Inventive Example |
| 16 | O | 1C | Yes | 27.86 | 30.59 | 62.31 | 53.47 | ◯ | 0.91 | ◯ | Inventive Example |
| 17 | P | 1C | Yes | 32.37 | 30.23 | 65.41 | 54.02 | ◯ | 0.92 | ◯ | Inventive Example |
| 18 | Q | 1C | Yes | 36.54 | 28.65 | 67.46 | 53.28 | ◯ | 0.91 | ◯ | Inventive Example |
| 19 | R | 1C | Yes | 35.64 | 27.46 | 65.35 | 51.85 | ◯ | 0.93 | ◯ | Inventive Example |
| 20 | S | 1C | Yes | 27.87 | 30.24 | 62.88 | 53.78 | ◯ | 0.89 | ◯ | Inventive Example |
| 21 | T | 1C | Yes | 29.02 | 26.98 | 63.45 | 52.87 | ◯ | 0.94 | ◯ | Inventive Example |
| 22 | U | 1C | Yes | 29.96 | 29.40 | 63.85 | 53.53 | ◯ | 0.98 | ◯ | Inventive Example |
| 23 | V | 1C | Yes | 30.31 | 29.96 | 63.89 | 53.61 | ◯ | 0.91 | ◯ | Inventive Example |
| 24 | W | 1C | Yes | 28.62 | 29.64 | 66.95 | 56.27 | ◯ | 0.89 | ◯ | Inventive Example |
| 25 | X | 1C | Yes | 30.20 | 42.75 | 65.32 | 58.50 | ◯ | 0.94 | ◯ | Inventive Example |
| 26 | D | IB | Yes | 31.28 | 28.80 | 63.56 | 52.69 | ◯ | Omitted | — | Inventive Example |
| 27 | D | ID | Yes | 29.87 | 2822 | 62.35 | 52.16 | ◯ | Omitted | — | Inventive Example |
| 28 | D | 1E | Yes | 27.23 | 27.98 | 64.53 | 54.58 | ◯ | Omitted | — | Inventive Example |
| 20 | D | 1F | Yes | 23.07 | 28.55 | 65.45 | 56.94 | ◯ | Omitted | — | Inventive Example |
| 30 | D | 1G | Yes | 30.08 | 29.02 | 63.78 | 53.32 | ◯ | Omitted | — | Inventive Example |
| 31 | D | 1H | Yes | 34.23 | 28.87 | 63.56 | 51.69 | ◯ | Omitted | — | Inventive Example |
| 32 | D | 11 | Yes | 30.89 | 29.58 | 72.56 | 59.28 | ◯ | Omitted | — | Inventive Example |
| 33 | D | 1J | Yes | 30.12 | 29.13 | 64.52 | 53.86 | ◯ | Omitted | — | Inventive Example |
| 34 | D | 1C | Yes | 35.64 | 22.43 | 56.89 | 44.61 | X | 0.85 | ◯ | Comparative Example |
| 35 | D | 1C | Yes | 34.02 | 33.80 | 68.68 | 56.81 | ◯ | 0.92 | ◯ | Inventive Example |
| 36 | D | 1C | Yes | 30.15 | 48.98 | 70.46 | 63.98 | ◯ | 0.94 | ◯ | Inventive Example |
| 37 | D | 1C | Yes | 31.25 | 55.80 | 78.02 | 71.08 | ◯ | 0.96 | ◯ | Inventive Example |
| 38 | D | 1C | Yes | 30.32 | 59.67 | 79.90 | 73.77 | ◯ | 0.97 | ◯ | Inventive Example |
| 39 | D | 1C | Yes | 32.32 | 61.23 | 80.56 | 74.31 | ◯ | 1.05 | X | Comparative Example |

It is understood that all Examples of the present invention have excellent thermal conductivity as high as thermal conductivity rate at 300° C. satisfies 25 W/m·K or more in a functional member side layer, 60 W/m·K or more in a supporting member side layer, and 45 W/m·K or more in an entire valve seat insert (average) and also have superior wear resistance comparable to current valve seat inserts. On the other hand, although in a comparative example, which is out of the scope of the present invention, a desired superior thermal conductivity is not obtained or a desired superior thermal conductivity is satisfied but the wear resistance is remarkably deteriorated.

### REFERENCE SIGNS LIST

2 Setting jig
3 Heat source
4 Valve
10 Valve seat insert
11 Functional member side layer
12 Supporting member side layer

1. A valve seat insert made of an iron-base sintered alloy for internal combustion engines, the valve seat insert being formed by integrating two of a functional member side layer and a supporting member side layer, wherein
Cu is infiltrated in pores of the functional member side layer and the supporting member side layer,
a valve contacting face is formed on the functional member side layer, and
the valve seat insert is superior in thermal conductivity as a thermal conductivity rate of the functional member side layer at 300° C. is 25 W/m·K or more, a thermal conductivity rate of the supporting member side layer at 300° C. is 60 W/m·K or more, and a thermal conductivity rate of the valve seat insert at 300° C. is 45 W/m·K or more on average.

2. The valve seat insert made of an iron-base sintered alloy for internal combustion engines according to claim 1, wherein the functional member side layer accounts for 10 to 40% by volume % with respect to the entire valve seat insert.

3. The valve seat insert made of an iron-base sintered alloy for internal combustion engines according to claim 1, wherein the functional member side layer is a layer that comprises a matrix part in which hard particles are dispersed in a matrix phase and pores filled with Cu by infiltration, wherein the matrix phase has a matrix phase structure including a fine carbide precipitation phase in an amount of 15% or more in volume % with respect to the entire matrix phase and less than 80% including 0% of a tempered martensite phase or pearlite, a martensite phase and a high alloy phase, the matrix part has a matrix part structure formed by dispersing the hard particles with a Vickers hardness of 600 to 1200 HV, 10 to 30% in volume % with respect to the entire matrix part in the matrix phase, and a matrix part composition which contains C: 0.5 to 2.0% in mass % with respect to the entire matrix part and contains one kind or two or more kinds selected from among Co, Mo, Si, Cr, Ni, Mn, W, V, S, Ca, F, Cu and Mg in a total amount of 45% or less, with the balance being Fe and unavoidable impurities, and further contains the Cu filled in the pores by infiltration in an amount of 10 to 35% in volume % with respect to the entire functional member side layer, and
the supporting member side layer is a layer that comprises a matrix phase and pores filled with Cu by infiltration, wherein the matrix phase has a matrix phase composition which contains C: 0.5 to 2.0% in mass % with respect to the entire matrix phase with the balance being Fe and unavoidable impurities, and further contains the Cu filled in the pores by infiltration in an amount of 15 to 35% in volume % with respect to the entire supporting member side layer.

4. The valve seat insert made of an iron-base sintered alloy for internal combustion engines according to claim 1, wherein the functional member side layer includes, in addition to the matrix part structure, a matrix part structure formed by dispersing solid lubricant particles in an amount of 0.1 to 5.0% in volume % with respect to the entire matrix part.

5. The valve seat insert made of an iron-base sintered alloy for internal combustion engines according to claim 3, wherein the supporting member side layer has, in addition to the matrix phase composition, a matrix phase composition containing one kind or two or more kinds selected from among Mo, Si, Cr, Ni, Mn, W, V, S, Cu and Co in a total amount of 10% or less in mass % with respect to the entire matrix phase.

6. The valve seat insert made of an iron-base sintered alloy for internal combustion engines according to claim 3, wherein instead of the supporting member side layer, the supporting member side layer is a layer that has a matrix phase and pores filled with Cu by infiltration, includes a matrix part formed by dispersing solid lubricant particles in the matrix phase, has a matrix part structure formed by dispersing the solid lubricant particles in an amount of 0.1 to 4.0% in volume % with respect to the entire matrix part and a matrix part composition containing C: 0.5 to 2.0% in mass % with respect to the entire matrix part and containing one kind or two or more kinds selected from among Mo, Si, Cr, Ni, Mn, W, V, S, Ca, F, Cu, Co and Mg in a total amount of 15% or less, and further contains the Cu filled in the pores by infiltration in an amount of 15 to 35% in volume % with respect to the entire supporting member side layer.

7. The valve seat insert made of an iron-base sintered alloy for internal combustion engines according to claim 2, wherein the functional member side layer is a layer that comprises a matrix part in which hard particles are dispersed in a matrix phase and pores filled with Cu by infiltration, wherein the matrix phase has a matrix phase structure including a fine carbide precipitation phase in an amount of 15% or more in volume % with respect to the entire matrix phase and less than 80% including 0% of a tempered martensite phase or pearlite, a martensite phase and a high alloy phase, the matrix part has a matrix part structure formed by dispersing the hard particles with a Vickers hardness of 600 to 1200 HV, 10 to 30% in volume % with respect to the entire matrix part in the matrix phase, and a matrix part composition which contains C: 0.5 to 2.0% in mass % with respect to the entire matrix part and contains one kind or two or more kinds selected from among Co, Mo, Si, Cr, Ni, Mn, W, V, S, Ca, F, Cu and Mg in a total amount of 45% or less, with the balance being Fe and unavoidable impurities, and further contains the Cu filled in the pores by infiltration in an amount of 10 to 35% in volume % with respect to the entire functional member side layer, and
the supporting member side layer is a layer that comprises a matrix phase and pores filled with Cu by infiltration, wherein the matrix phase has a matrix phase composition which contains C: 0.5 to 2.0% in mass % with respect to the entire matrix phase with the balance being Fe and unavoidable impurities, and further contains the Cu filled in the pores by infiltration in an amount of 15 to 35% in volume % with respect to the entire supporting member side layer.

8. The valve seat insert made of an iron-base sintered alloy for internal combustion engines according to claim 2, wherein the functional member side layer includes, in addition to the matrix part structure, a matrix part structure formed by dispersing solid lubricant particles in an amount of 0.1 to 5.0% in volume % with respect to the entire matrix part.

9. The valve seat insert made of an iron-base sintered alloy for internal combustion engines according to claim 3, wherein the functional member side layer includes, in addition to the matrix part structure, a matrix part structure formed by dispersing solid lubricant particles in an amount of 0.1 to 5.0% in volume % with respect to the entire matrix part.

10. The valve seat insert made of an iron-base sintered alloy for internal combustion engines according to claim 7, wherein the functional member side layer includes, in addition to the matrix part structure, a matrix part structure formed by dispersing solid lubricant particles in an amount of 0.1 to 5.0% in volume % with respect to the entire matrix part.

11. The valve seat insert made of an iron-base sintered alloy for internal combustion engines according to claim 4, wherein the supporting member side layer has, in addition to the matrix phase composition, a matrix phase composition containing one kind or two or more kinds selected from among Mo, Si, Cr, Ni, Mn, W, V, S, Cu and Co in a total amount of 10% or less in mass % with respect to the entire matrix phase.

12. The valve seat insert made of an iron-base sintered alloy for internal combustion engines according to claim 7, wherein the supporting member side layer has, in addition to the matrix phase composition, a matrix phase composition containing one kind or two or more kinds selected from among Mo, Si, Cr, Ni, Mn, W, V, S, Cu and Co in a total amount of 10% or less in mass % with respect to the entire matrix phase.

13. The valve seat insert made of an iron-base sintered alloy for internal combustion engines according to claim 4, wherein instead of the supporting member side layer, the supporting member side layer is a layer that has a matrix phase and pores filled with Cu by infiltration, includes a matrix part formed by dispersing solid lubricant particles in the matrix phase, has a matrix part structure formed by dispersing the solid lubricant particles in an amount of 0.1 to 4.0% in volume % with respect to the entire matrix part and a matrix part composition containing C: 0.5 to 2.0% in mass % with respect to the entire matrix part and containing one kind or two or more kinds selected from among Mo, Si, Cr, Ni, Mn, W, V, S, Ca, F, Cu, Co and Mg in a total amount of 15% or less, and further contains the Cu filled in the pores by infiltration in an amount of 15 to 35% in volume % with respect to the entire supporting member side layer.

14. The valve seat insert made of an iron-base sintered alloy for internal combustion engines according to claim 7, wherein instead of the supporting member side layer, the supporting member side layer is a layer that has a matrix phase and pores filled with Cu by infiltration, includes a matrix part formed by dispersing solid lubricant particles in the matrix phase, has a matrix part structure formed by dispersing the solid lubricant particles in an amount of 0.1 to 4.0% in volume % with respect to the entire matrix part and a matrix part composition containing C: 0.5 to 2.0% in mass % with respect to the entire matrix part and containing one kind or two or more kinds selected from among Mo, Si, Cr, Ni, Mn, W, V, S, Ca, F, Cu, Co and Mg in a total amount of 15% or less, and further contains the Cu filled in the pores by infiltration in an amount of 15 to 35% in volume % with respect to the entire supporting member side layer.

15. The valve seat insert made of an iron-base sintered alloy for internal combustion engines according to claim 8, wherein the supporting member side layer has, in addition to the matrix phase composition, a matrix phase composition containing one kind or two or more kinds selected from among Mo, Si, Cr, Ni, Mn, W, V, S, Cu and Co in a total amount of 10% or less in mass % with respect to the entire matrix phase.

16. The valve seat insert made of an iron-base sintered alloy for internal combustion engines according to claim 9, wherein the supporting member side layer has, in addition to the matrix phase composition, a matrix phase composition containing one kind or two or more kinds selected from among Mo, Si, Cr, Ni, Mn, W, V, S, Cu and Co in a total amount of 10% or less in mass % with respect to the entire matrix phase.

17. The valve seat insert made of an iron-base sintered alloy for internal combustion engines according to claim 10, wherein the supporting member side layer has, in addition to the matrix phase composition, a matrix phase composition containing one kind or two or more kinds selected from among Mo, Si, Cr, Ni, Mn, W, V, S, Cu and Co in a total amount of 10% or less in mass % with respect to the entire matrix phase.

18. The valve seat insert made of an iron-base sintered alloy for internal combustion engines according to claim 8, wherein instead of the supporting member side layer, the supporting member side layer is a layer that has a matrix phase and pores filled with Cu by infiltration, includes a matrix part formed by dispersing solid lubricant particles in the matrix phase, has a matrix part structure formed by dispersing the solid lubricant particles in an amount of 0.1 to 4.0% in volume % with respect to the entire matrix part and a matrix part composition containing C: 0.5 to 2.0% in mass % with respect to the entire matrix part and containing one kind or two or more kinds selected from among Mo, Si, Cr, Ni, Mn, W, V, S, Ca, F, Cu, Co and Mg in a total amount of 15% or less, and further contains the Cu filled in the pores by infiltration in an amount of 15 to 35% in volume % with respect to the entire supporting member side layer.

19. The valve seat insert made of an iron-base sintered alloy for internal combustion engines according to claim 9, wherein instead of the supporting member side layer, the supporting member side layer is a layer that has a matrix phase and pores filled with Cu by infiltration, includes a matrix part formed by dispersing solid lubricant particles in the matrix phase, has a matrix part structure formed by dispersing the solid lubricant particles in an amount of 0.1 to 4.0% in volume % with respect to the entire matrix part and a matrix part composition containing C: 0.5 to 2.0% in mass % with respect to the entire matrix part and containing one kind or two or more kinds selected from among Mo, Si, Cr, Ni, Mn, W, V, S, Ca, F, Cu, Co and Mg in a total amount of 15% or less, and further contains the Cu filled in the pores by infiltration in an amount of 15 to 35% in volume % with respect to the entire supporting member side layer.

20. The valve seat insert made of an iron-base sintered alloy for internal combustion engines according to claim 10, wherein instead of the supporting member side layer, the supporting member side layer is a layer that has a matrix phase and pores filled with Cu by infiltration, includes a matrix part formed by dispersing solid lubricant particles in the matrix phase, has a matrix part structure formed by dispersing the solid lubricant particles in an amount of 0.1 to 4.0% in volume % with respect to the entire matrix part and a matrix part composition containing C: 0.5 to 2.0% in mass % with respect to the entire matrix part and containing one kind or two or more kinds selected from among Mo, Si, Cr, Ni, Mn, W, V, S, Ca, F, Cu, Co and Mg in a total amount of 15% or less, and further contains the Cu filled in the pores by infiltration in an amount of 15 to 35% in volume % with respect to the entire supporting member side layer.
